(19) United States
(12) Patent Application Publication
(10) Pub. No.: US 2019/0297529 A1
(43) Pub. Date: Sep. 26, 2019

(54) EXTENSION OF LOGICAL CHANNEL NUMBER IN CELLULAR RADIO ACCESS TECHNOLOGIES

(71) Applicant: QUALCOMM Incorporated, San Diego, CA (US)

(72) Inventors: Karl Georg HAMPEL, Hoboken, NJ (US); Junyi LI, Chester, NJ (US); Hong CHENG, Bridgewater, NJ (US); Navid ABEDINI, Somerset, NJ (US); Muhammad Nazmul ISLAM, Littleton, MA (US); Jianghong LUO, Skillman, NJ (US)

(21) Appl. No.: 16/358,435

(22) Filed: Mar. 19, 2019

Related U.S. Application Data
(60) Provisional application No. 62/647,533, filed on Mar. 23, 2018.

(51) Int. Cl. H04W 28/06; H04L 29/08; H04W 80/04; H04W 72/10; H04W 76/11

(52) U.S. Cl. CPC H04W 28/06; H04L 69/325; H04W 76/11; H04W 72/10; H04W 80/04

(57) ABSTRACT

An aspect of the present disclosure includes methods, systems, and computer-readable media for appending an extension header to a medium access control (MAC) sub-header, wherein the extension header includes information related to an extension of a logical channel range, indicating the appending of the extension header by an indicator in the MAC sub-header, and transmitting the MAC sub-header.

### CROSS REFERENCE TO RELATED APPLICATIONS

The present application claims priority to U.S. Provisional Application No. 62/647,533, filed on Mar. 23, 2018, entitled “Extension of Logical Channel Number in Cellular Radio Access Technologies,” the content of which is incorporated by reference in its entirety.

### BACKGROUND

Aspects of the present disclosure relate generally to wireless communication networks, and more particularly, to apparatus and methods of assigning logical channel numbers in a multi-hop backhaul network.

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which may be referred to as new radio (NR)) is envisaged to expand and support diverse usage scenarios and applications with respect to current mobile network generations. In an aspect, 5G communications technology may include: enhanced mobile broadband addressing human-centric use cases for access to multimedia content, services and data; ultra-reliable-low latency communications (URLLC) with certain specifications for latency and reliability; and massive machine type communications, which may allow a very large number of connected devices and transmission of a relatively low volume of non-delay-sensitive information. As the demand for mobile broadband access continues to increase, however, further improvements in NR communications technology and beyond may be desired.

In a wireless communication network, multi-hop backhauling using 5G NR permits the cellular coverage range for NR access to be extended. This scenario may lead to scheduling and quality of service (QoS) issues, however, due to capacity constraints and increased latency on the multi-hop wireless backhaul Thus, improvement in wireless communication networks are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The described aspects of the present disclosure include a method relating to wireless communication that may operate at a network entity (e.g., a base station, gNB, gNB centralized unit (CU), control function, . . . ) to append an extension header to a medium access control (MAC) sub-header, wherein the extension header includes information related to an extension of a logical channel range, indicate the appending of the extension header by an indicator in the MAC sub-header, and transmit the MAC sub-header.

Another aspect of the present disclosure includes a base station having a memory, a transceiver, and one or more processors operatively coupled to the memory and the transceiver and configured to append an extension header to a MAC sub-header, wherein the extension header includes information related to an extension of a logical channel range, indicate the appending of the extension header by an indicator in the MAC sub-header, and transmit the MAC sub-header.

One aspect of the present disclosure includes a non-transitory computer-readable medium having instructions stored therein that, when executed by one or more processors at a base station, cause the one or more processors to append an extension header to a MAC sub-header, wherein the extension header includes information related to an extension of a logical channel range, indicate the appending of the extension header by an indicator in the MAC sub-header, and transmit the MAC sub-header.

Certain aspects of the disclosure includes methods, apparatuses, and computer-readable media relating to wireless communication that may operate at other network entities (e.g., a base station, gNB, gNB CU, control function, . . . ) to detect the extended logical channel identifier (xLCID) embedded in the MAC sub-header (via indicators in the sub-header), map the data in the sub-header to the corresponding logical channel based on the xLCID, unpack the sub-header, and forward the service data unit (SDU) within the sub-header to the mapped logical channel.

Additional aspects may include complimentary methods, apparatuses, and computer-readable media relating to wireless communication that may operate at other corresponding network entities (e.g., relay base stations, gNBs, gNB distributed units (DU), . . . ) and/or user equipment to receive the MAC sub-header with the indicator and appended extension header to obtain the information related to the extension of the logical channel range.

For example, such methods may include receiving, at a user equipment, a MAC sub-header, identifying an indicator in the MAC sub-header that indicates presence of an extension header having information related to an extension of a logical channel range, reading the extension header to obtain an extended logical channel identifier corresponding to the extension of the logical channel range, and configuring an extended logical channel based on the extended logical channel identifier.

Other aspects of the present disclosure may include a user equipment having a memory, a transceiver, and one or more processors operatively coupled to the memory and the transceiver and configured to receiving, at the user equipment, a MAC sub-header, identifying an indicator in the MAC sub-header that indicates presence of an extension header having information related to an extension of a logical channel range, reading the extension header to obtain an extended logical channel identifier corresponding to the extension of the logical channel range, and configuring an extended logical channel based on the extended logical channel identifier.

Certain aspects of the present disclosure includes a non-transitory computer-readable medium having instructions stored therein that, when executed by one or more processors at a user equipment, cause the one or more processors to receiving, at the user equipment, a MAC sub-header, identifying an indicator in the MAC sub-header that indicates presence of an extension header having information related to an extension of a logical channel range, reading the extension header to obtain an extended logical channel identifier corresponding to the extension of the logical channel range, and configuring an extended logical channel based on the extended logical channel identifier.

Some aspects of the present disclosure include a method relating to wireless communication that may operate at a network entity (e.g., a base station, gNB, gNB CU, control function, . . . ) to receive, at base station, a MAC sub-header, determine a presence of an extension header based on a value of an indicator in the MAC sub-header, retrieve an xLCID from the extension header, extract a MAC SDU from the MAC sub-header, and forward the MAC SDU to a logical channel based on the xLCID.

Another aspect of the present disclosure includes a base station having a memory, a transceiver, and one or more processors operatively coupled to the memory and the transceiver and configured to receive, via the transceiver, a MAC sub-header, determine a presence of an extension header based on a value of an indicator in the MAC sub-header, retrieve an xLCID from the extension header, extract a MAC SDU from the MAC sub-header, and forward the MAC SDU to a logical channel based on the xLCID.

One aspect of the present disclosure includes a non-transitory computer-readable medium having instructions stored therein that, when executed by one or more processors at a base station, cause the one or more processors to receive, at base station, a MAC sub-header, determine a presence of an extension header based on a value of an indicator in the MAC sub-header, retrieve an xLCID from the extension header, extract a MAC SDU from the MAC sub-header, and forward the MAC SDU to a logical channel based on the xLCID.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example of a wireless communication network including at least one base station and one user equipment;

FIG. 2 is an example of a network that provides range extension via wireless backhaul;

FIG. 3 is an example of an integrated access and backhaul network;

FIG. 4 is an example of a network where UE-bearer awareness is retained on each backhaul link;

FIG. 5 is an example of a table including indices and values in a logical channel identifier (LCID) for a downlink shared channel (DL-SCH);

FIG. 6 is an example of a table including indices and values in an LCID for an uplink shared channel (UL-SCH);

FIG. 7 is a schematic diagram including examples of MAC sub-header formats each including a limited length LCID field that may be supplemented according to the described aspects to enable logical channel range extension, the formats respectively without a length field or with length fields of different lengths;

FIG. 8 is a schematic diagrams of different examples of a MAC sub-header including different types of an extension header configured to enable logical channel range extension according to the described aspects;

FIG. 9 is a flowchart of an example of a method of wireless communication that enables logical channel range extension;

FIG. 10 is a flowchart of an example of a method of wireless communication that forwards MAC sub-headers with logical channel range extension;

FIG. 11 is a flowchart of another example of a method of wireless communication that receives MAC sub-headers with logical channel range extension

FIG. 12 is a schematic diagram of an example of a user equipment; and

FIG. 13 is a schematic diagram of an example of a base station.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium, such as a computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 902.11 (Wi-Fi), IEEE 902.16 (WiMAX), IEEE 902.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A and/or 5G New Radio (NR) system for purposes of example, and LTE or 5G NR terminology is used in much of the description below, although the techniques are applicable beyond LTE/LTE-A and 5G NR applications, e.g., to other next generation communication systems).

Aspects of the present disclosure relate to logical channel range extension using a MAC sub-header having a limited length LCD. For instance, the limited length LCID may not be sized to support, on its own, signaling the logical channel range extension. As such, the limited length LCID has a length shorter than a traditional LCD. In some implementations, these aspects may apply to 5G NR and, specifically, to wireless multi-hop backhauling using 5G NR such as Integrated-Access and Backhaul (IAB) networks. In other implementations, the present disclosure may relate to 4G/Long Term Evolution (LTE).

Accordingly, an aspect of the present disclosure includes methods, systems, and computer-readable media for appending an extension header to the MAC sub-header, wherein the extension header includes information related to an extension of a logical channel range. The aspects further include indicating the appending of the extension header by an indicator in the MAC sub-header, and transmitting the MAC sub-header.

The extension of the logical channel range may be used for MAC and L3 signaling. The indicator in the MAC sub-header flags whether the MAC SDU pertains to a logical channel of extended range. For example, the reserved bit in the MAC sub-header may be used as the indicator. In other examples, an unused LCID value may be used as the indicator. When the indicator in the MAC sub-header indicates such range extension, information on the xLCID of the SDU's logical channel is carried in the extension header appended to the MAC sub-header. This extension header may include a value that identifies the xLCID, or a suffix to the presently existing LCID that, when combined, identifies the xLCID. Optionally, the extension header may further include other information or identifiers, such as but not limited to, one or any combination of a routing identification (ID), an adaptation-layer ID, a UE-access bearer ID, a tunnel ID, or a flow ID, a sequence number, control bits or reserved bits, a length field or a type field or a value field.

Further, L3 message extensions may include an indicator for support of xLCID in a capabilities message, and/or configuration of an extended xLCID range, and/or indication of the use of the extended logical channel range. The L3 protocols used to convey these messages may include a radio resource control (RRC) protocol or a fronthaul application protocol (F1-AP).

Thus, based on the described aspects, wireless backhauling may provide coverage range extension to a wireline backhaul or fronthaul including use of logical channel range extensions to support MAC scheduling an QoS of the traffic between the backhaul or fronthaul nodes. A wireless backhaul network may support multiple backhaul hops as well as redundant connectivity, e.g. by providing multiple paths between a donor node and a relay node. One example for wireless backhauling is Integrated Access and Backhaul (IAB). The donor may be referred to the node that interfaces between wireless and the wireline networks.

To deliver data across such a wireless multi-hop backhaul network, the present aspects may support use of a routing mechanism. This routing mechanism may be accommodated at Layer 2.

In some implementations of the present disclosure, it may be advantageous to provide fine-granular QoS-support on the wireless backhaul links due to the limited backhaul capacity and due to the hop-count dependence latency. Since on access links, QoS may be enforced with UE-bearer granularity, it may be desirable to extend this QoS granularity also to the backhaul links. The transmitting side of each backhaul link may have a separate queue for each UE-bearer, whose data is backhauled on that link. Accordingly, the present disclosure enables such QoS granularity by providing methods, apparatus, and computer-readable medium that support logical channel range extension using the MAC sub-header having the appended extension header as described herein.

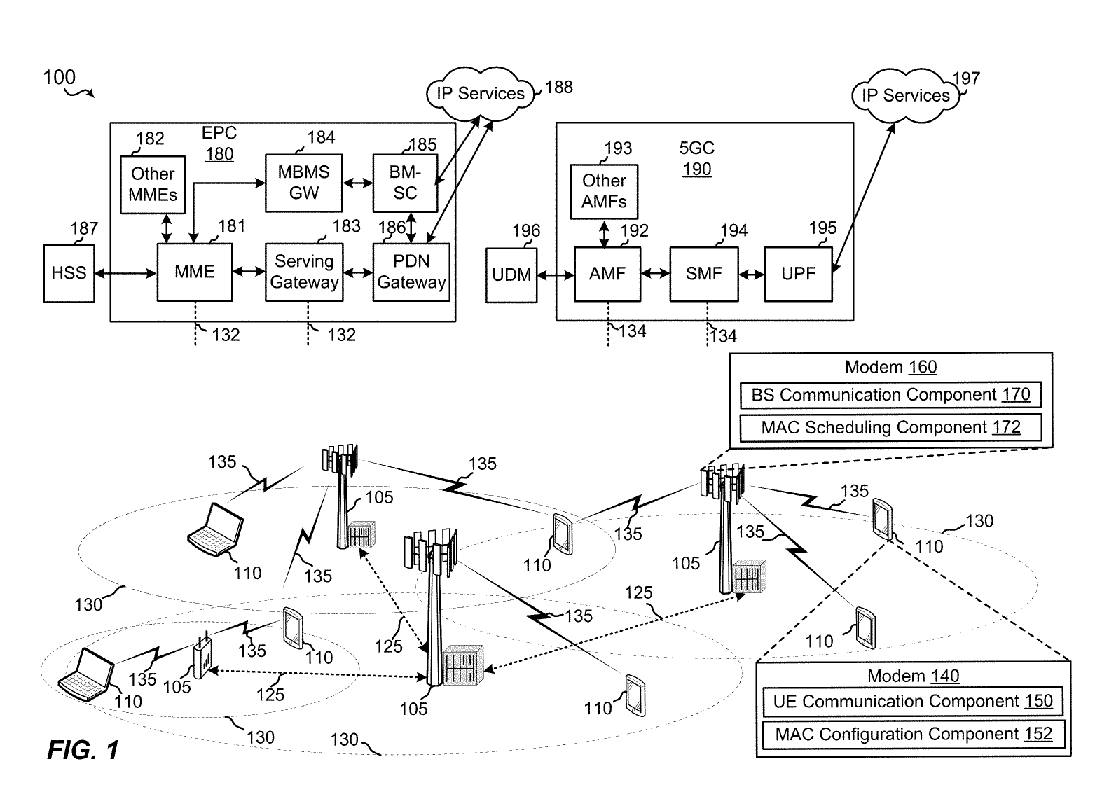

Referring to FIG. 1, in accordance with various aspects of the present disclosure, a wireless communication network 100 includes at least one UE 110 including a modem 140 with a UE communication component 150 configured to transmit and receive data, such as MAC PDUs and L3 messages, respectively to and from a base station 105. The modem 140 further includes a MAC configuration component 152 configured to analyze MAC sub-headers identify the presence of extended logical channel utilization. The MAC configuration component 152 may also configure the extended logical channel based on the xLCID in the received MAC sub-header.

In some implementations, a modem 160 of the BS 105 includes a BS communication component 170 configured to transmit and receive data, such as MAC PDUs and/or L3 messages, respectively to and from the BS 105 and UE 110. The modem 160 may include a MAC scheduling component 172 that may append extension headers and indicators to a MAC sub-header prior to transmission to indicate and configure a logical channel range extension.

The modem 160 of the base station 105 may be configured to communicate with other base stations 105 and UEs 110 via a cellular network, a Wi-Fi network, or other wireless and wireline networks. The modem 140 of the UE 110 may be configured to communicate with the base stations 105 via a cellular network, a Wi-Fi network, or other wireless and wireline networks. The modems 140, 160 may receive and transmit data packets, including transmitting or receiving the MAC sub-header including an appended extension header having information relating to a logical channel range extension, as is described in more detail in the description of the subsequent figures.

The wireless communication network 100 may include one or more base stations 105, one or more UEs 110, and a core network, such as an Evolved Packet Core (EPC) 180 and/or a 5G core (5GC) 190. The EPC 180 and/or the 5GC 190 may provide user authentication, access authorization, tracking, interne protocol (IP) connectivity, and other access, routing, or mobility functions. The base stations 105 configured for 4G LTE (collectively referred to as Evolved Universal Mobile Telecommunications System (UMTS) Terrestrial Radio Access Network (E-UTRAN)) may interface with the EPC 180 through backhaul links 132 (e.g., NG, S1, etc.). The base stations 105 configured for 5G NR (collectively referred to as Next Generation RAN (NG-RAN)) may interface with the 5GC 190 through backhaul links 134. In addition to other functions, the base stations 105 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 105 may communicate with each other directly or indirectly (e.g., through EPC 180 or the 5GC 190), with one another over backhaul links 125, 132, or 134 (e.g., Xn, or X2 interfaces). The backhaul links 125, 132, 134 may be wired or wireless communication links.

The base stations 105 may wirelessly communicate with the UEs 110 via one or more base station antennas. Each of the base stations 105 may provide communication coverage for a respective geographic coverage area 130. In some examples, the base stations 105 may be referred to as a base transceiver station, a radio base station, an access point, an access node, a radio transceiver, a NodeB, eNodeB (eNB), gNB, Home NodeB, a Home eNodeB, a relay, a transceiver function, a basic service set (BSS), an extended service set (ESS), a transmit reception point (TRP), or some other suitable terminology. The geographic coverage area 130 for a base station 105 may be divided into sectors or cells making up only a portion of the coverage area (not shown). The wireless communication network 100 may include base stations 105 of different types (e.g., macro base stations or small cell base stations, described below). Additionally, the plurality of base stations 105 may operate according to different ones of a plurality of communication technologies (e.g., 5G (New Radio or “NR”), fourth generation (4G)/LTE, 3G, Wi-Fi, Bluetooth, etc.), and thus there may be overlapping geographic coverage areas 130 for different communication technologies.

In some examples, the wireless communication network 100 may be or include one or any combination of communication technologies, including a NR or 5G technology, a LTE or LTE-Advanced (LTE-A) or MuLTEfire technology, a Wi-Fi technology, a Bluetooth technology, or any other long or short range wireless communication technology. In LTE/LTE-A/MuLTEfire networks, the term evolved node B (eNB) may be generally used to describe the base stations 105, while the term UE may be generally used to describe the UEs 110. The wireless communication network 100 may be a heterogeneous technology network in which different types of eNBs provide coverage for various geographical regions. For example, each eNB or base station 105 may provide communication coverage for a macro cell, a small cell, or other types of cell. The term “cell” is a 3GPP term that may be used to describe a base station, a carrier or component carrier associated with a base station, or a coverage area (e.g., sector, etc.) of a carrier or base station, depending on context.

A macro cell may generally cover a relatively large geographic area (e.g., several kilometers in radius) and may allow unrestricted access by UEs 110 with service subscriptions with the network provider.

A small cell may include a relative lower transmit-powered base station, as compared with a macro cell, that may operate in the same or different frequency bands (e.g., licensed, unlicensed, etc.) as macro cells. Small cells may include pico cells, femto cells, and micro cells according to various examples. A pico cell, for example, may cover a small geographic area and may allow unrestricted access by UEs 110 with service subscriptions with the network provider. A femto cell may also cover a small geographic area (e.g., a home) and may provide restricted access and/or unrestricted access by UEs 110 having an association with the femto cell (e.g., in the restricted access case, UEs 110 in a closed subscriber group (CSG) of the base station 105, which may include UEs 110 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The communication networks that may accommodate some of the various disclosed examples may be packet-based networks that operate according to a layered protocol stack and data in the user plane may be based on the IP. A user plane protocol stack (e.g., packet data convergence protocol (PDCP), radio link control (RLC), MAC, etc.), may perform packet segmentation and reassembly to communicate over logical channels. For example, a MAC layer may perform priority handling and multiplexing of logical channels into transport channels. The MAC layer may also use hybrid automatic repeat/request (HARD) to provide retransmission at the MAC layer to improve link efficiency. In the control plane, the RRC protocol layer may provide establishment, configuration, and maintenance of an RRC connection between a UE 110 and the base stations 105. The RRC protocol layer may also be used for the EPC 180 or the 5GC 190 support of radio bearers for the user plane data. At the physical (PHY) layer, the transport channels may be mapped to physical channels.

The UEs 110 may be dispersed throughout the wireless communication network 100, and each UE 110 may be stationary or mobile. A UE 110 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 110 may be a cellular phone, a smart phone, a personal digital assistant (PDA), a wireless modem, a wireless communication device, a handheld device, a tablet computer, a laptop computer, a cordless phone, a smart watch, a wireless local loop (WLL) station, an entertainment device, a vehicular component, a customer premises equipment (CPE), or any device capable of communicating in wireless communication network 100. Some non-limiting examples of UEs 110 may include a session initiation protocol (SIP) phone, a satellite radio, a global positioning system, a multimedia device, a video device, a digital audio player (e.g., MP3 player), a camera, a game console, a smart device, a wearable device, a vehicle, an electric meter, a gas pump, a large or small kitchen appliance, a healthcare device, an implant, a sensor/actuator, a display, or any other similar functioning device. Additionally, a UE 110 may be Internet of Things (IoT) and/or machine-to-machine (M2M) type of device, e.g., a low power, low data rate (relative to a wireless phone, for example) type of device, that may in some aspects communicate infrequently with wireless communication network 100 or other UEs. Some examples of IoT devices may include parking meter, gas pump, toaster, vehicles, and heart monitor. A UE 110 may be able to communicate with various types of base stations 105 and network equipment including macro eNBs, small cell eNBs, macro gNBs, small cell gNBs, relay base stations, and the like.

UE 110 may be configured to establish one or more wireless communication links 135 with one or more base stations 105. The wireless communication links 135 shown in wireless communication network 100 may carry uplink (UL) transmissions from a UE 110 to a base station 105, or downlink (DL) transmissions, from a base station 105 to a UE 110. The downlink transmissions may also be called forward link transmissions while the uplink transmissions may also be called reverse link transmissions. Each wireless communication link 135 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. In an aspect, the wireless communication links 135 may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2). Moreover, in some aspects, the wireless communication links 135 may represent one or more broadcast channels.

In some aspects of the wireless communication network 100, base stations 105 or UEs 110 may include multiple antennas for employing antenna diversity schemes to improve communication quality and reliability between base stations 105 and UEs 110. Additionally or alternatively, base stations 105 or UEs 110 may employ multiple input multiple output (MIMO) techniques that may take advantage of multi-path environments to transmit multiple spatial layers carrying the same or different coded data.

Wireless communication network 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 110 may be configured with multiple downlink CCs and one or more uplink CCs for carrier aggregation. Carrier aggregation may be used with both FDD and TDD component carriers. The communication links 135 may use multiple-input and multiple-output (MIMO) antenna technology, including spatial multiplexing, beamforming, and/or transmit diversity. The base stations 105 and/or UEs 110 may use spectrum up to Y MHz (e.g., 5, 10, 15, 20, 30, 50, 100, 200, 400, etc., MHz) bandwidth per carrier allocated in a carrier aggregation of up to a total of Yₓ MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 110 may communicate with each other using device-to-device (D2D) communication link 138. The D2D communication link 138 may use the DL/UL WWAN spectrum. The D2D communication link 138 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications network 100 may further include base stations 105 operating according to Wi-Fi technology, e.g., Wi-Fi access points, in communication with UEs 110 operating according to Wi-Fi technology, e.g., Wi-Fi stations (STAs) via communication links in an unlicensed frequency spectrum (e.g., 5 GHz). When communicating in an unlicensed frequency spectrum, the STAs and AP may perform a clear channel assessment (CCA) or listen before talk (LBT) procedure prior to communicating in order to determine whether the channel is available.

The small cell may operate in a licensed and/or an unlicensed frequency spectrum. When operating in an unlicensed frequency spectrum, the small cell may employ NR and use the same 5 GHz unlicensed frequency spectrum as used by the Wi-Fi AP. The small cell, employing NR in an unlicensed frequency spectrum, may boost coverage to and/or increase capacity of the access network.

A base station 105, whether a small cell or a large cell (e.g., macro base station), may include an eNB, gNodeB (gNB), or other type of base station. Some base stations 105, such as a gNB may operate in a traditional sub 6 GHz spectrum, in millimeter wave (mmW) frequencies and/or near mmW frequencies in communication with the UE 110. When the gNB, such as a base station 105 operates in mmW or near mmW frequencies, the base station 105 may be referred to as an mmW base station. Extremely high frequency (EHF) is part of the radio frequency (RF) in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band has extremely high path loss and a short range. The mmW base station 105 may utilize beamforming with the UEs 110 in their transmissions to compensate for the extremely high path loss and short range.

In a non-limiting example, the EPC 180 may include a Mobility Management Entity (MME) 181, other MMES 182, a Serving Gateway 183, a Multimedia Broadcast Multicast Service (MBMS) Gateway 184, a Broadcast Multicast Service Center (BM-SC) 185, and a Packet Data Network (PDN) Gateway 186. The MME 181 may be in communication with a Home Subscriber Server (HSS) 187. The MME 181 is the control node that processes the signaling between the UEs 110 and the EPC 180. Generally, the MME 181 provides bearer and connection management. All user Internet protocol (IP) packets are transferred through the Serving Gateway 183, which itself is connected to the PDN Gateway 186. The PDN Gateway 186 provides UE IP address allocation as well as other functions. The PDN Gateway 186 and the BM-SC 185 are connected to the IP Services 188. The IP Services 188 may include the Internet, an intranet, an IP Multimedia Subsystem (IMS), a PS Streaming Service, and/or other IP services. The BM-SC 185 may provide functions for MBMS user service provisioning and delivery. The BM-SC 185 may serve as an entry point for content provider MBMS transmission, may be used to authorize and initiate MBMS Bearer Services within a public land mobile network (PLMN), and may be used to schedule MBMS transmissions. The MBMS Gateway 184 may be used to distribute MBMS traffic to the base stations 105 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 110 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

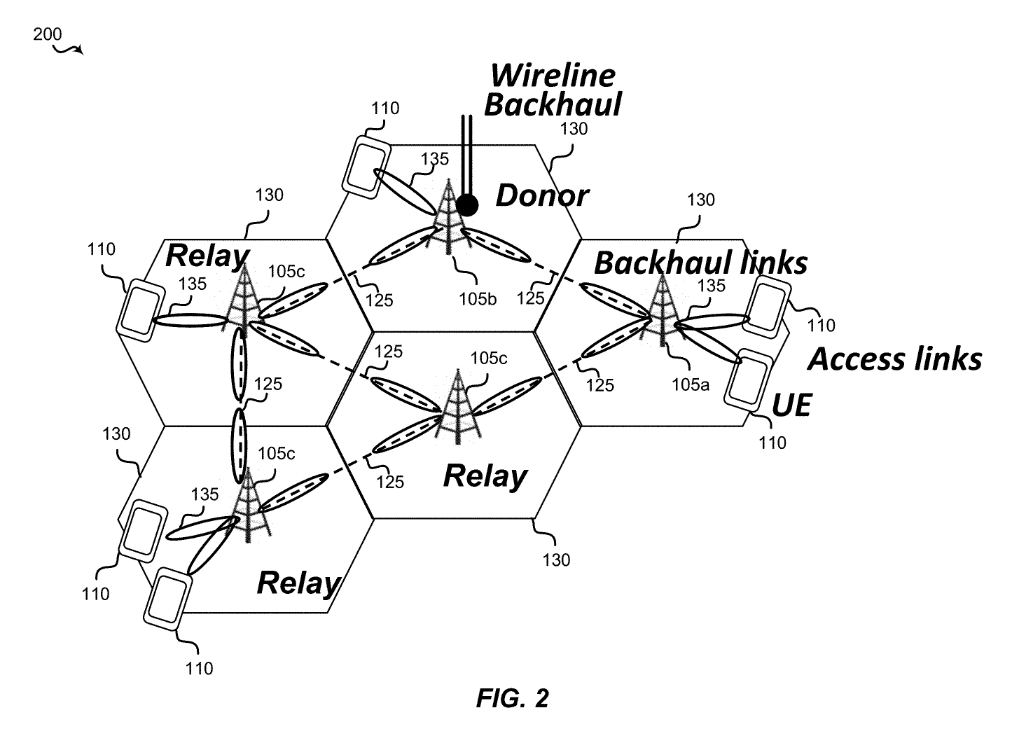

Referring to FIG. 2, an example of a network 200 provides wireless network coverage range extension via wireless backhaul. It should be noted that this is one non-limiting example, and that other configurations of a network may also provide wireless network coverage range extension via wireless backhaul. The BSs 105 may include a gNB-centralized-unit (gNB CU) BS 105a, a gNB-distributed-unit (gNB DU) BS 105b, and relay BSs 105c. The gNB BS 105a, gNB DU BS 105b, and relay BSs 105c may have coverage areas 130. The gNB CU BS 105a may connect to the gNB DU BS 105b and the relay BSs 105c via one or more of the backhaul links 125, 132, 134. For example, the gNB CU BS 105a may connect the gNB DU BS 105b and the relay BSs 105c directly via the backhaul links 125 or indirectly (through the EPC 180 and/or 5GC 190) via the backhaul links 132, 134. In certain implementations, the gNB CU BS 105a may connect to the gNB DU BS 105b via the one or more of the wireline backhaul links 125, 132, 134 and to the relay BSs 105c via the one or more of the wireless backhaul links 125, 132, 134. The one or more of the wireless backhaul links 125, 132, 134 may include narrow beams (e.g., using beamforming). In other examples, the gNB CU BS 105a may connect to the gNB DU BS 105b and the relay BSs 105c via the one or more of the wireline backhaul links 125, 132, 134. The gNB CU BS 105a may extend the coverage areas 130 by communicating with the UEs 110 through the gNB DU BS 105b and/or the relays. For example, some of the UEs 110 may be beyond the coverage area of the gNB CU BS 105a. The gNB CU BS 105a may be unable to directly establish communication links 135 with the UEs 110. By communicating via the gNB DU BS 105b and the relays 105c, the gNB CU BS 105a may be able to communicate with the UEs 110 beyond the coverage area 130 of the gNB CU BS 105a. In some examples, a split architecture may be used, where a centralized unit and a donor unit reside within the same gNB. In other examples, a gNB centralized unit is collocated with the gNB DU BS 105b. In certain implementations, the gNB CU 105a may be a relay. In other implementations, the gNB CU 105a may reside within a cloud and accessible via the one or more of the wireline or wireless backhaul links 125, 132, 134 (e.g. fiber).

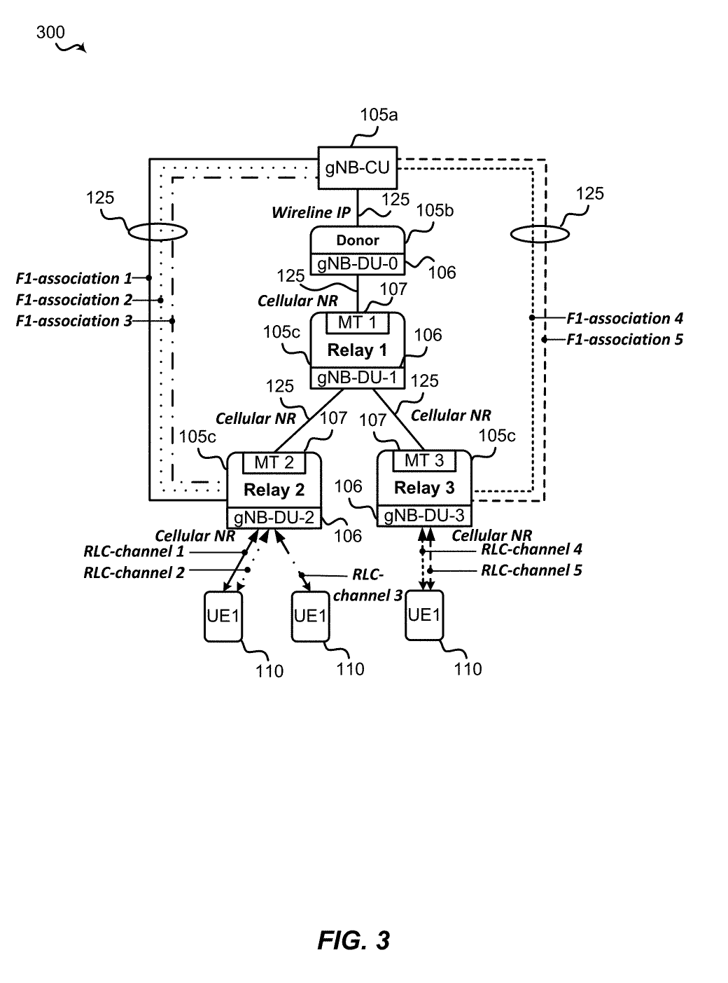

Referring to FIG. 3, an example of a network 300 includes an integrated access and backhaul (IAB) network where the UEs 110 access the relay BS 105c, which may be backhauled (e.g., via a wireless or wireline communication link) to the gNB DU BS 105b (e.g., a donor node). The architecture of network 300 may use a CU/DU split. Each relay 105c may hold a gNB DU 106 while the gNB CU BS 105a may reside in a data center. The UEs 110 and the gNB-CU BS 105a may sustain one or more bearers, where each bearer includes a RLC-channel between the UEs 110 and the gNB-DUs 106 of the relays 105c and a F1-association between the gNB-DUs 106 of the relays 105c and the gNB-CU 105a. This F1 association is carried over the one or more of the wireless and/or the wireline backhaul links 125, 132, 134. The one or more of the wireless backhaul links 125, 132, 134 may reuse NR Uu interface. The one or more of the backhaul link 125, 132, 134 may include a mobile termination function (MT) 107 at one link end point and the gNB-DU 106 at the other end. In this manner, RLC-channels between the MTs 107 and gNB-DUs 106 may be established for the one or more of the backhaul links 125, 132, 134.

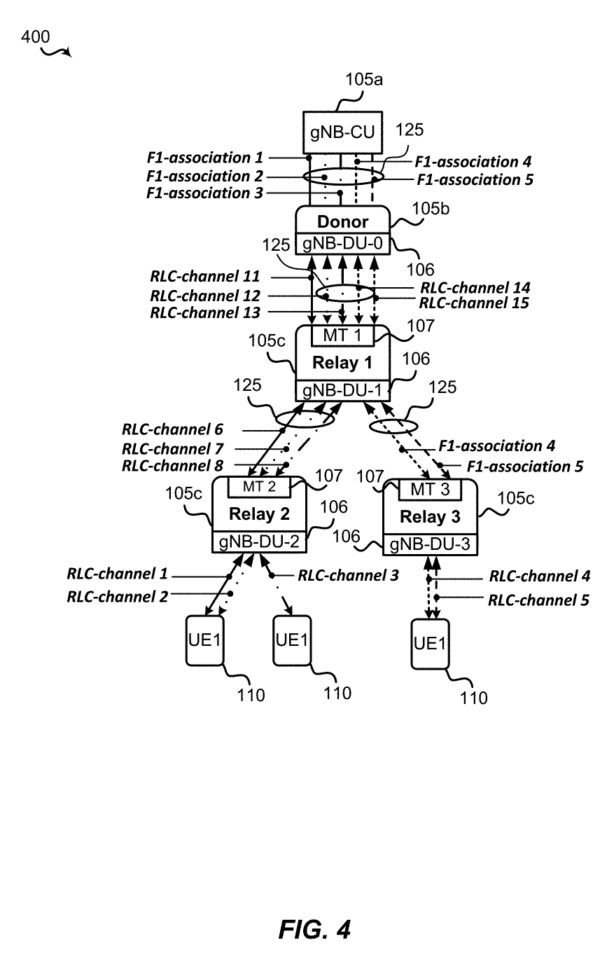

Referring to FIG. 4, an example of a network 400, similar to network 300, where UE-bearer awareness is retained on each of the one or more of the backhaul link 125, 132, 134 by carrying each of the UE-bearer's F1-association hop-by-hop via a separate RLC-bearer chain across the backhaul. For example, F1-association 1 may be supported via the chain of RLC channels 6 and 11; F1-assocation 2 may be supported via the chain of RLC channels, 7 and 12; F1-association 3 may be supported via the chain of RLC channels 8 and 13; F1-assocation 4 may be supported via the chain of RLC channels, 9 and 14; F1-assocation 5 may be supported via the chain of RLC channels, 10 and 15. The transmitters on the one or more of the backhaul links 125, 132, 134 may support separate queues for each RLC channel. In this manner, the MAC scheduler on each of the one or more of the backhaul link 125, 132, 134 may enforce separate UE-bearer-specific quality of service (QoS). The RLC-bearer chain may be mapped by a mapping retained in a memory of gNB-CU 105a, all or a portion of which may be shared with the other nodes in the architecture (e.g., donor node 105b, relays 105c).

Further, each relay 105c may hold a routing entry for each UE-bearer it backhauls. In some examples, an adaptation layer may be inserted into a protocol stack of the relays, where the adaptation layer carries UE-bearer-specific information.

In this architecture, as the number of UEs 110 increases, an LCID in the MAC sub-header may be insufficient to represent the logical channels allocated, such as the RLC channels. For example, if the LCID includes 5 usable bits to represent the logical channels, at any given time, the most number of distinct logical channels that may be allocated may be 32. In another example, if the LCID includes 6 usable bits, the most number of distinct channels may be 64.

Accordingly, based on the present disclosure, in some implementations, the gNB CU BS 105a may append an extension header to the MAC sub-header when the LCID becomes insufficient to represent the logical channels in order to support an extension of the logical channel range. The extension header includes information relating to the logical channel range extension. Further, the gNB CU BS 105a may identify the presence of the extension header by including an indicator in the MAC sub-header, where the indicator may be, for example, a value of a reserved bit or a value of the LCD.

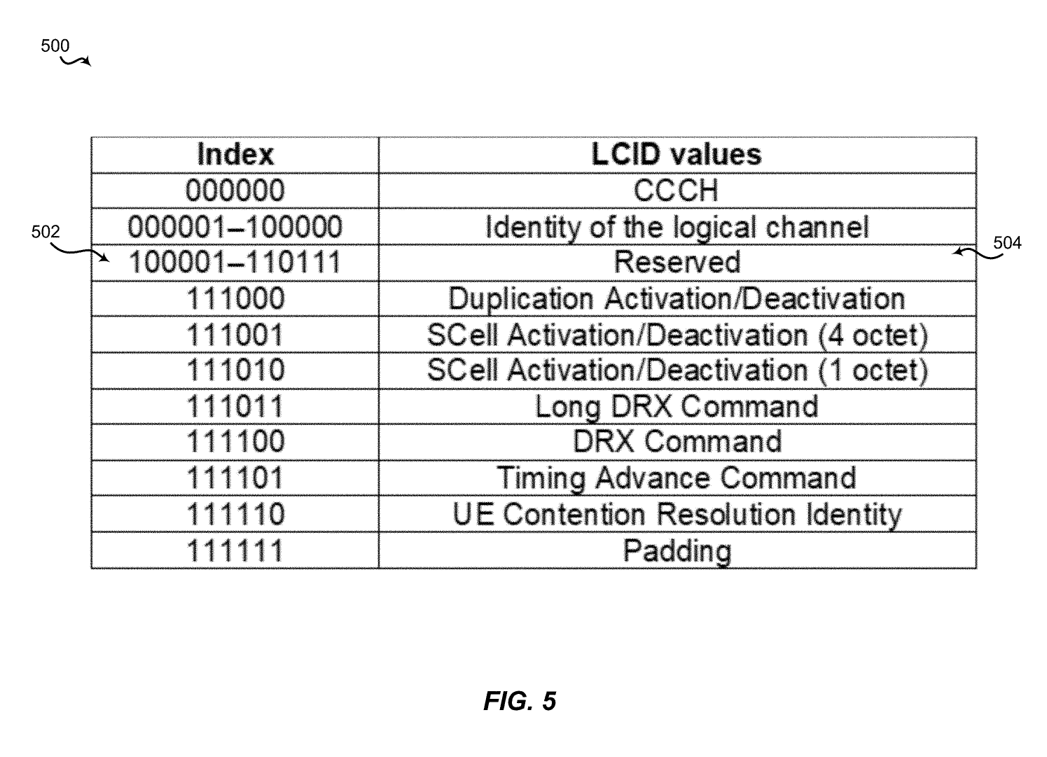

Turning now to FIG. 5, an example of a table 500 includes indices and values in an LCID for a downlink shared channel (DL-SCH), where one or more index values 502 associated with a corresponding one or more reserved LCID values 504 may be used as the indicator of presence or support of the extension header in the MAC sub-header. The values of the LCD, represented with 6 bits for example, may represent a common control channel (CCCH) field, an identity of the logical channel field, a reserved field, a duplication activation/deactivation field, a first SCell activation/deactivation field, a second SCell activation/deactivation field, a long discontinuous reception (DRX) command field, a DRX command field, a timing advance command field, a UE contention resolution identity field, and a padding field. In certain examples, the identity of the logical channel field may include 5 bits, allowing the gNB CU BS 105a, gNB DU BS 105b, or the relay BSs 105c to allocate a maximum of 32 distinct logical channels. In other examples, the number of distinct logical channels may be lower.

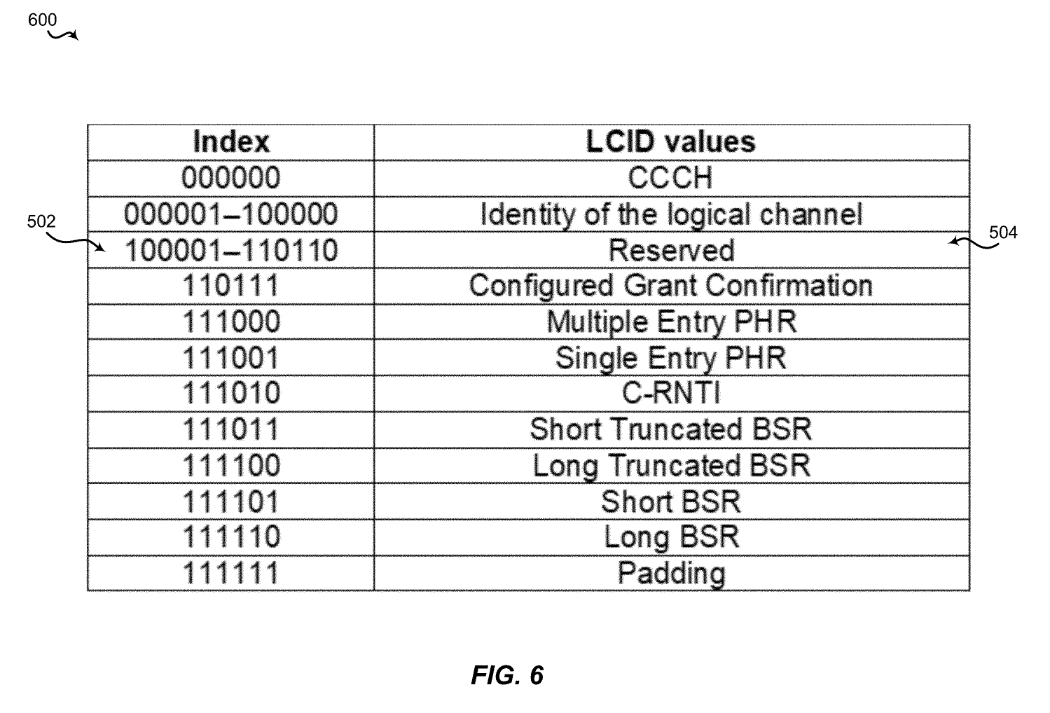

Turning now to FIG. 6, an example of a table 600 includes values and fields in an LCID for an uplink shared channel (UL-SCH), where one or more index values 602 associated with a corresponding one or more reserved LCID values 604 may be used as the indicator of presence or support of the extension header in the MAC sub-header. The values of the LCD, represented with 6 bits for example, may represent a common control channel (CCCH) field, an identity of the logical channel field, a reserved field, a configured grant confirmation field, a multiple entry power headroom report (PHR) field, a single PHR field, a cell radio network temporary identifier (C-RNTI) field, a short truncated buffer status report (BSR), a long truncated BSR field, a short BSR field, a long BSR field, and a padding field. In certain examples, the identity of the logical channel field may include 5 bits, allowing the gNB CU to allocate a maximum of 32 distinct logical channels. In other examples, the number of distinct logical channels may be lower.

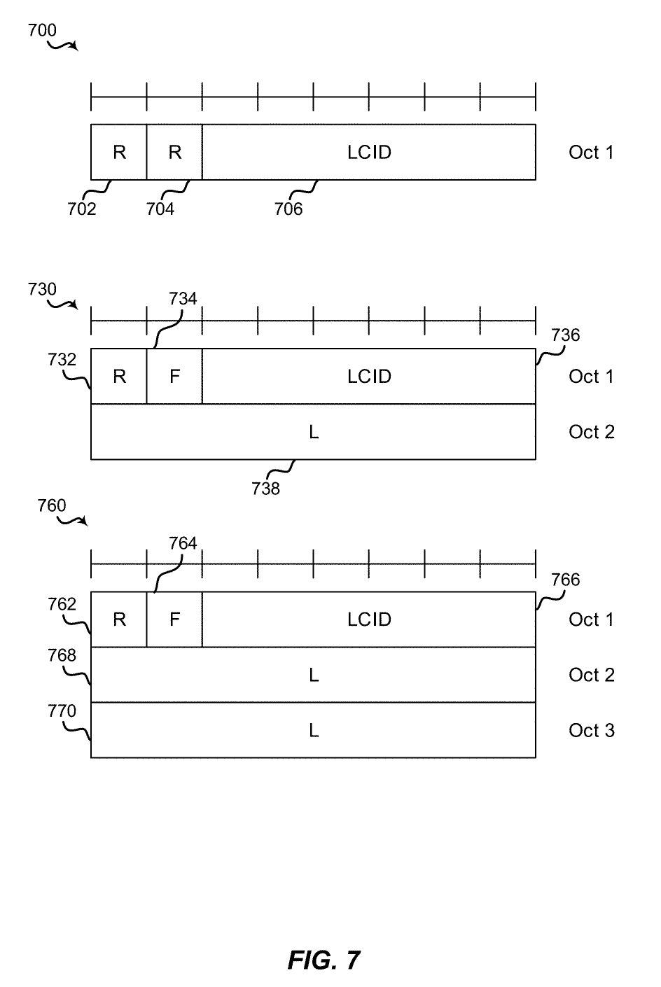

Turning now to FIG. 7, different examples of different types of MAC sub-header formats, one or more of which may be used with the present aspects. MAC sub-header 700 is a format without length field. The sub-header 700 may include a first reserved field 702, a second reserved field 704, and an LCID field 706. The first reserved field 702 and the second reserved field 704 may be 1-bit fields that may be used to transmit information in the MAC sub-header 700. The LCID field 706 may be an LCID for a downlink shared channel (DL-SCH) as shown in FIG. 5 or an LCID for an uplink shared channel (UL-SCH) as shown in FIG. 6. In some examples, the LCID field 706 may include 6 bits, with 5 bits reserved for identifying the logical channels (i.e. 32 distinct channels). In other examples, the LCID field 706 may support less than 32 distinct channels.

Still referring to FIG. 7, an example of another MAC sub-header format includes a MAC sub-header 730 having a reserved field 732, a format field 734, an LCID field 736, and an 8-bit length field 738. The LCID field 736 may be an LCID for a downlink shared channel (DL-SCH) as shown in FIG. 5 or an LCID for an uplink shared channel (UL-SCH) as shown in FIG. 6. In some examples, the LCID field 736 may include 6 bits, with 5 bits reserved for identifying the logical channels (i.e. 32 distinct channels). In other examples, the LCID field 736 may support less than 32 distinct channels.

Still referring to FIG. 7, another example of a MAC sub-header format includes MAC sub-header 760 having a reserved field 762, a format field 764, an LCID field 766, and 8-bit length fields 768, 770. The LCID field 766 may be an LCID for a downlink shared channel (DL-SCH) as shown in FIG. 5 or an LCID for an uplink shared channel (UL-SCH) as shown in FIG. 6. In some examples, the LCID field 736 may include 6 bits, with 5 bits reserved for identifying the logical channels (i.e. 32 distinct channels). In other examples, the LCID field 766 may support less than 32 distinct channels. The MAC sub-headers 700, 730, 760 may be unable to handle xLCID.

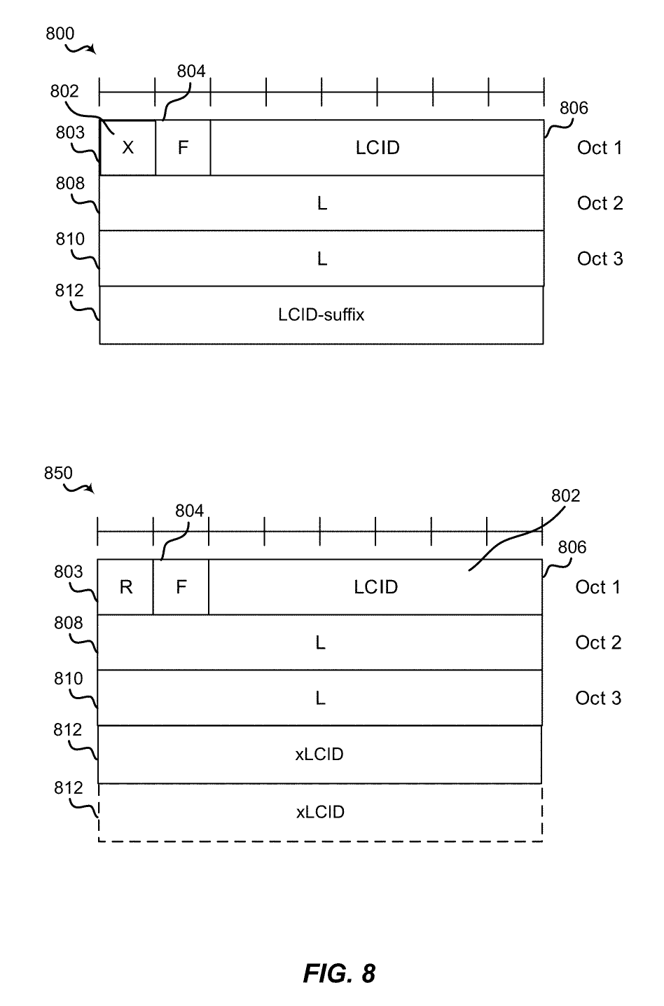

Referring to FIG. 8, different examples of different types of logical channel extension indicators and extension headers may be used in a MAC sub-header.

For instance, in one example, a MAC sub-header 800 includes indicator 802 as a value in a reserved field 803 and an appended extension header 812. In this case, the extension header 812 may include a value of an LCID-suffix, which in combination with a value (e.g., a dedicated LCID value) of an LCID field 806 identifies the logical channel extension. For instance, a first portion of the bits in the xLCID may be stored in the LCID field 806, and a second portion of the bits may be stored in the extension header 812. In one implementation, the xLCID may include 14 bits, with 6 bits stored in the LCID field 806 and 8 bits stored in the extension header 812. For example, the xLCID may include sufficient bits to resolve 16,384 distinct logical channels. In other implementations, the extension header 812 may include more or less than 14 bits.

In another example, a MAC sub-header 850 includes indicator 802 in the LCID field 806 and one or more appended extension headers 812, e.g., depending on how much information is being conveyed. In this case, at least one of the one or more appended extension headers 812 includes a value that identifies the logical channel extension. For example, the LCID field 806 may store a predetermined value indicating the xLCID. The predetermined value may be a dedicated LCID value indicating the xLCID. For instance, in some implementations, a first portion of the bits in the xLCID may be stored in a first extension header 812, and a second portion of the bits may be stored in a second extension header 812. In one example, the xLCID may include 16 bits, with 8 bits stored in the first extension header 812 and 8 bits stored in the second extension header 812. For example, the xLCID may include sufficient bits to resolve 65,536 distinct logical channels. In other implementations, the extension header 812 may include more or less than 16 bits.

MAC sub-header 800 or 850 further includes a format field 804, and length fields 808, 810 (e.g., 8 bits each).

The MAC sub-header 800 or 850 may be sent from the gNB CU BS 105a to the gNB DU BS 105b or the relay BSs 105c indicating an xLCID for a logical channel. The gNB DU BS 105b or the relay BS 105c may relay the MAC sub-header 800 or 850. In other examples, the MAC sub-header 800 or 850 may be sent from the gNB DU BS 105b to the gNB CU BS 105a or the relay BSs 105c. In certain examples, the relays may transmit the MAC sub-header 800 or 850 to the gNB CU BS 105a or the gNB DU BS 105b.

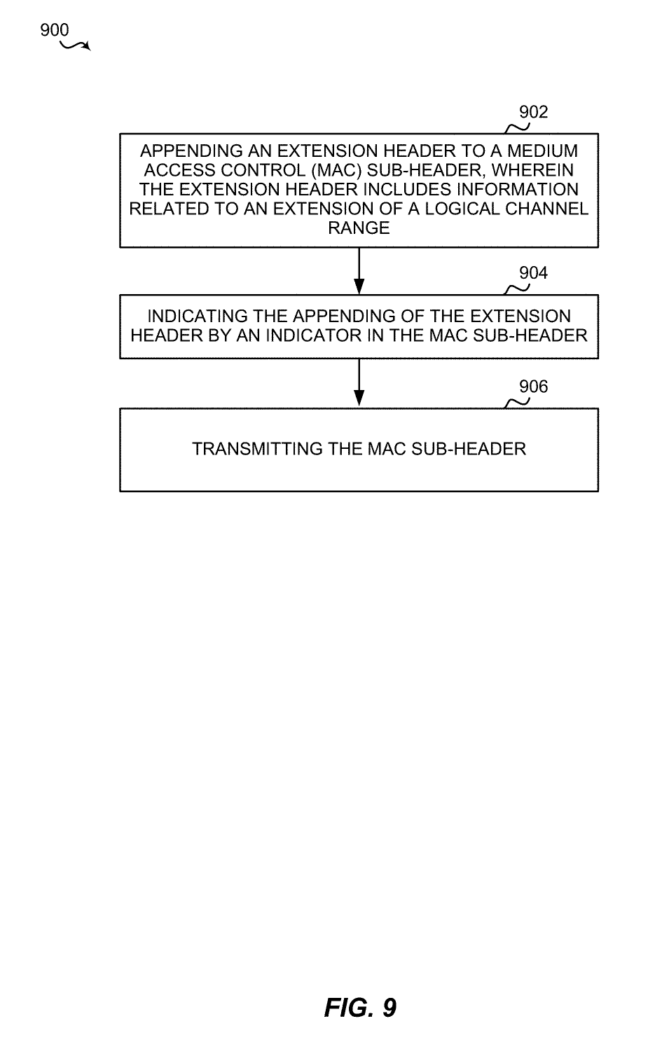

Referring to FIG. 9, the gNB CU BS 105a, the gNB DU BS 105b, or the relay BS 105c may perform an example of a method 900 of wireless communication, including extending the range of logical channels by appending extension headers to MAC sub-headers. In an example, the extension may permit MAC PDUs from different UEs 110 be given different priorities and/or QoS. In some implementations, method 900 may be based on UEs 110 providing logical channel capability information to the gNB CU BS 105a, or a control function within the wireless network, thereby leading to the subsequent configuration of the extended logical control channel.

At block 902, the method 900 may append an extension header to a MAC sub-header, wherein the extension header includes information related to an extension of a logical channel range. For example, the MAC scheduling component 172 may append an extension header 812 having a value of an LCD-suffix, which may be combined with the value of the LCID to identify the xLCID, or may append one or more extension headers 812 having all or a portion of a value of the xLCID fields. As such, the one or more extension headers 812 may contain a portion of the xLCID assigned by the MAC scheduling component 172. In certain implementations, the MAC scheduling component 172 may place a first portion of bits (e.g. 5 bits) in the LCID field of a MAC sub-header and a second portion of bits (e.g. 7 bits), e.g., the LCD-suffix, in the extension header 812 appended to the MAC sub-header 800. In other implementations, the MAC scheduling component 172 may place all of the xLCID in the extension header 812 appended to the MAC sub-header 850. In other implementations, the MAC scheduling component 172 may place a first portion of bits (e.g. 6 bits), e.g., a first portion of the xLCID, in a first extension header 812 appended to the MAC sub-header 850, and a second portion of bits (e.g. 6 bits), e.g., the second portion of the xLCID, in a second extension header 812 appended to the MAC sub-header 850. In one example, the MAC scheduling component 172 may use on the extension header, such as the LCD-suffix field or the one or more xLCID fields, to extend the range of logical channels for use in communicating data with a UE in the network. In some examples, certain values of the xLCID may be used for MAC Control Elements. The extension header 812 may be of fixed or variable lengths. The extension header 812 may optionally include one or more length fields. The extension header 812 may optionally include one or more identifiers, such as a routing ID, an adaptation-layer ID, UE-access bearer ID, a tunnel ID, or a flow ID. The extension header 812 may optionally include one or more of a sequence number, control bits, or reserved bits. Further, the extension header 812 may optionally include a length field or a type field or a value field.

At block 904, the method 900 may indicate the appending of the extension header by an indicator in the MAC sub-header. For example, the MAC scheduling component 172 may set the bit(s) of a reserved field 803 of the MAC sub-header 800 to a predetermined value of the indicator 802 to indicate the appending of the extension header 812. In another example, the MAC scheduling component 172 may set the bit(s) of the LCD field 806 to another predetermined value of the indicator 802 to indicate the appending of the extension header 812.

At block 906, the method 900 may transmit the MAC sub-header. For example, the BS communication component 170 may transmit the MAC sub-header 800 or 850, including the appended extension header 812 and the indicator 802, to the gNB CU BS 105a, the gNB DU BS 105b, or the relay BSs 105c.

In optional implementations, the BS 105 (e.g. gNB CU BS 105a, gNB DU BS 105b, or relay BS 105c) may transmit one or more Layer-3 (L3) messages to other BSs 105 to indicate support for xLCID. For example, the one or more L3 messages may include a capability message indicating that the BS 105 is configured to support xLCID. The one or more L3 messages may further include a configurations message indicating the extended range of the xLCID and/or and the use of the extended range. The one or more L3 messages may utilize Layer-3 protocols such as the Radio Resource Control (RRC) protocol or the Fronthaul Application protocol (F1-AP). In certain implementations, the one or more L3 messages may include an L3 control message that includes a mapping from one extended logical channel link to another.

Certain aspects of the disclosure includes methods, apparatuses, and computer-readable media relating to wireless communication that may operate at other network entities (e.g., a base station, gNB, gNB centralized unit (CU), control function, . . . ) to detect the xLCID embedded in the MAC sub-header (via indicators in the sub-header), map the data in the sub-header to the corresponding logical channel based on the xLCID, unpack the sub-header, and forward the SDU within the sub-header to the mapped logical channel.

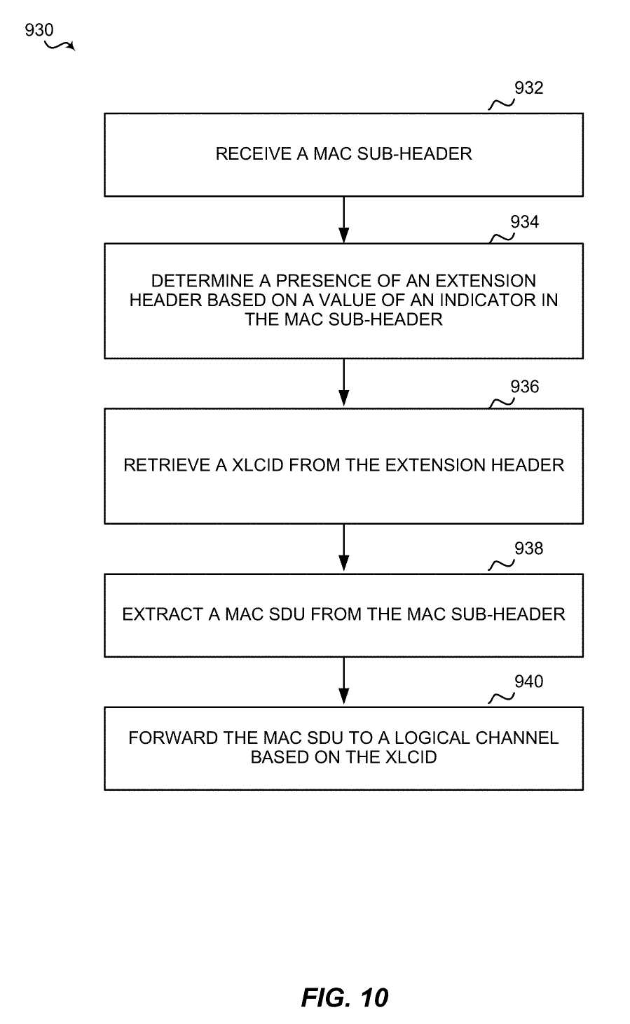

Referring to FIG. 10, in some implementations, the gNB CU BS 105a, the gNB DU BS 105b, or the relay BS 105c may perform an example of a method 930 of wireless communication, including forwarding received data into a mapped logical channel based on the xLCID associated with the data.

At block 932, the method 930 may receive a MAC sub-header. For example, the BS communication component 170 may receive the MAC sub-header from the gNB CU BS 105a, the gNB DU BS 105b, or the relay BS 105c.

At block 934, the method 930 may determine a presence of an extension header based on a value of an indicator in the MAC sub-header. For example, the MAC scheduling component 172 may determine that the MAC sub-header includes an extension header having an xLCID based on the value of the indicator. In a non-limiting example, the gNB CU BS 105a, the gNB DU BS 105b, or the relay BS 105c may determine the presence of the extension header 812 by examining the value of the indicator 802 in the reserved field 803 or the LCID 806 field .

At block 936, the method 930 may retrieve the xLCID from the extension header. For example, the MAC scheduling component 172 may retrieve the xLCID from the extension header, such as an LCD-suffix or xLCID fields. In some examples, the gNB CU BS 105a, the gNB DU BS 105b, or the relay BS 105c may retrieve the xLCID from the content in the extension header 812 and/or the LCID-suffix.

At block 938, the method 930 may extract a MAC SDU from the Mac sub-header. For example, the MAC scheduling component 172 may extract the SDU from the MAC sub-header, such as the extension header 812.

At block 940, the method 930 may forward the MAC SDU to a logical channel based on the xLCID. For example, the communication component 170 may forward the MAC SDU to a logical channel based on the xLCID.

Additional aspects may include complimentary methods relating to wireless communication that may operate at other corresponding network entities (e.g., relay base stations, gNBs, gNB distributed units (DU), . . . ) and/or user equipment to receive the MAC sub-header with the indicator and appended extension header to obtain the information related to the extension of the logical channel range.

For example, such methods may be executed by UE communication component 150, and may include receiving, at a user equipment, a MAC sub-header, identifying an indicator in the MAC sub-header that indicates presence of an extension header having information related to an extension of a logical channel range, reading the extension header to obtain an extended logical channel identifier corresponding to the extension of the logical channel range, and configuring an extended logical channel based on the extended logical channel identifier.

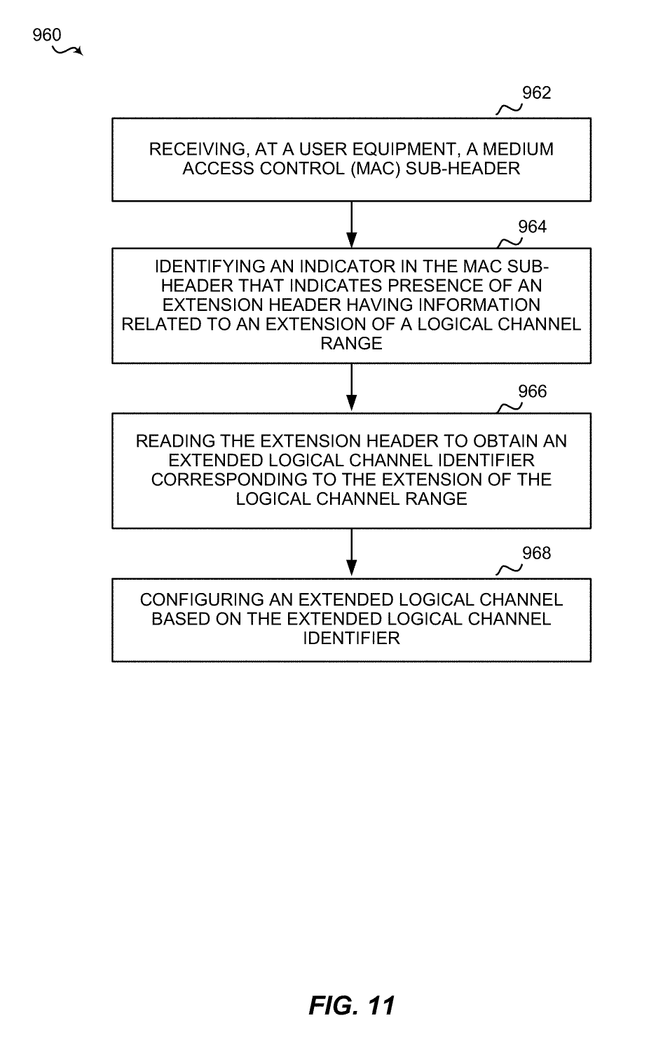

Referring to FIG. 11, the UE 110 may perform a method 960 of configuring an extended logical channel based on a MAC sub-header.

At block 962, the method 960 may receive a MAC sub-header. For example, the UE communication component 150 may receive a MAC sub-header sent by the gNB CU BS 105a, the gNB DU BS 105b, or the relay BS 105c, such as the MAC sub-headers 800, 850.

At block 964, the method 960 may identify an indicator in the MAC sub-header that indicates presence of an extension header having information related to an extension of a logical channel range. For example, the MAC configuration component 152 may identify an indicator, such as a reserved bit or a particular value of the LCD, in the MAC sub-header that indicates the extension of logical channel range. The MAC configuration component 152 of the UE 110 may examine the indicator 802 in the reserved field 803 or the LCID 806 field.

At block 966, the method 960 may read the extension header to obtain an extended logical channel identifier corresponding to the extension of the logical channel range. For example, the MAC configuration component 152 may read the extension header, which includes a LCD-suffix and/or xLCID, to obtain the xLCID value corresponding to the extension of the logical channel range. In a non-limiting example, the MAC configuration component 152 of the UE 110 may combine the LCID with the LCD-suffix to obtain the xLCID. In another example, the MAC configuration component 152 may obtain the xLCID from the extension headers 812.

At block 968, the method 960 may configure an extended logical channel based on the extended logical channel identifier. For example, the MAC configuration component 152 may configure an extended logical channel based on the xLCID.

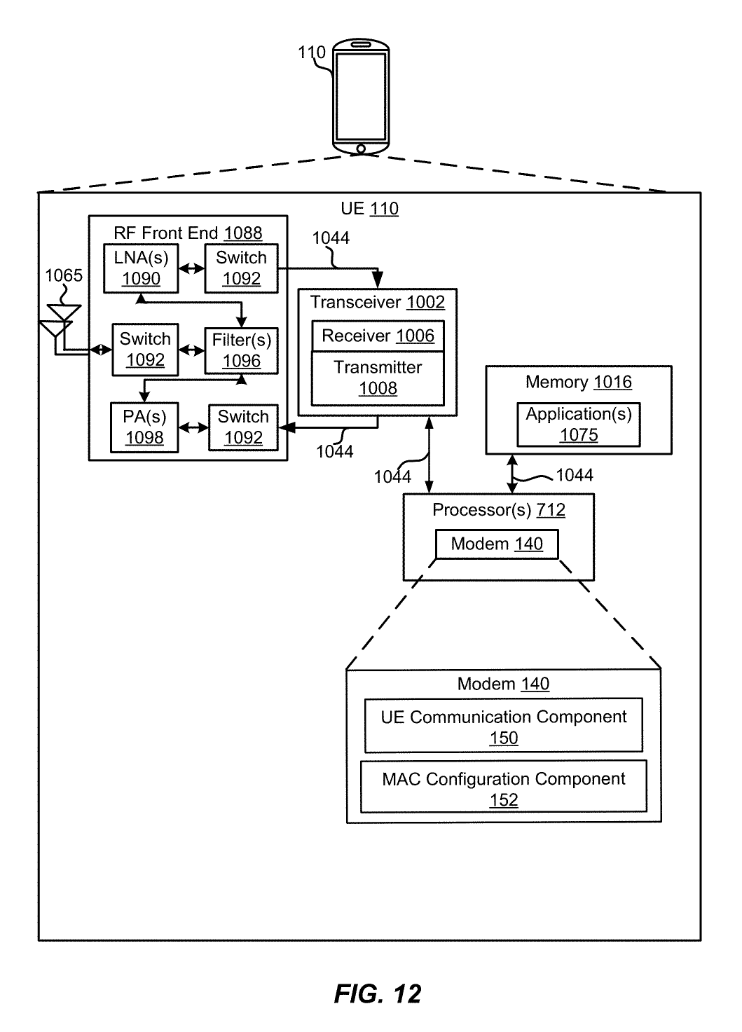

Referring to FIG. 12, one example of an implementation of the UE 110 may include a variety of components, some of which have already been described above, but including components such as one or more processors 1012 and memory 1016 and transceiver 1002 in communication via one or more buses 1044, which may operate in conjunction with the modem 140, the UE communication component 150, and the MAC configuration component 152 to enable one or more of the functions described herein related to communicating with the BS 105. Further, the one or more processors 1012, modem 140, memory 1016, transceiver 1002, RF front end 1088 and one or more antennas 1065, may be configured to support voice and/or data calls (simultaneously or non-simultaneously) in one or more radio access technologies.

In an aspect, the one or more processors 1012 may include the modem 140 that uses one or more modem processors. The various functions related to the UE communication component 150 and/or the MAC configuration component 152 may be included in modem 140 and/or processors 1012 and, in an aspect, may be executed by a single processor, while in other aspects, different ones of the functions may be executed by a combination of two or more different processors. For example, in an aspect, the one or more processors 1012 may include any one or any combination of a modem processor, or a baseband processor, or a digital signal processor, or a transmit processor, or a receiver processor, or a transceiver processor associated with transceiver 1002. In certain aspects, various functions relating to the UE communication component 150 the MAC configuration component 152 may be implemented in hardware, software, or a combination thereof. In other aspects, some of the features of the one or more processors 1012 and/or the modem 140 associated with the UE communication component 150 may be performed by transceiver 1002.

Also, memory 1016 may be configured to store data used herein and/or local versions of applications 1075 or the UE communication component 150 and/or one or more subcomponents of the UE communication component 150 being executed by at least one processor 1012. Memory 1016 may include any type of computer-readable medium usable by a computer or at least one processor 1012, such as random access memory (RAM), read only memory (ROM), tapes, magnetic discs, optical discs, volatile memory, non-volatile memory, and any combination thereof. In an aspect, for example, memory 1016 may be a non-transitory computer-readable storage medium that stores one or more computer-executable codes defining the UE communication component 150 and/or one or more of its subcomponents, and/or data associated therewith, when UE 110 is operating at least one processor 1012 to execute the UE communication component 150 and/or one or more of their subcomponents.

Transceiver 1002 may include at least one receiver 1006 and at least one transmitter 1008. Receiver 1006 may include hardware, firmware, and/or software code executable by a processor for receiving data, the code comprising instructions and being stored in a memory (e.g., computer-readable medium). The receiver 1006 may be, for example, a radio frequency (RF) receiver. In an aspect, the receiver 1006 may receive signals transmitted by the BS 105. Additionally, the receiver 1006, in conjunction with the computation component 150, may process such received signals, and also may obtain measurements of the signals, such as, but not limited to, Ec/Io, SNR, RSRP, RSSI, etc. Transmitter 1008 may include hardware, firmware, and/or software code executable by a processor for transmitting data, the code comprising instructions and being stored in a memory (e.g., computer-readable medium). A suitable example of transmitter 1008 may including, but is not limited to, an RF transmitter.

Moreover, in an aspect, the UE 110 may include RF front end 1088, which may operate in communication with one or more antennas 1065 and transceiver 1002 for receiving and transmitting radio transmissions, for example, wireless communications transmitted by the BS 105 or wireless transmissions transmitted by UE 110. RF front end 1088 may be coupled with one or more antennas 1065 and may include one or more low-noise amplifiers (LNAs) 1090, one or more switches 1092, one or more power amplifiers (PAs) 1098, and one or more filters 1096 for transmitting and receiving RF signals.

In an aspect, LNA 1090 may amplify a received signal at a desired output level. In an aspect, each LNA 1090 may have a specified minimum and maximum gain values. In an aspect, RF front end 1088 may use one or more switches 1092 to select a particular LNA 1090 and the specified gain value based on a desired gain value for a particular application.

Further, for example, one or more PA(s) 1098 may be used by RF front end 1088 to amplify a signal for an RF output at a desired output power level. In an aspect, each PA 1098 may have specified minimum and maximum gain values. In an aspect, RF front end 1088 may use one or more switches 1092 to select a particular PA 1098 and the specified gain value based on a desired gain value for a particular application.

Also, for example, one or more filters 1096 may be used by RF front end 1088 to filter a received signal to obtain an input RF signal. Similarly, in an aspect, for example, a respective filter 1096 may be used to filter an output from a respective PA 1098 to produce an output signal for transmission. In an aspect, each filter 1096 may be coupled with a specific LNA 1090 and/or PA 1098. In an aspect, RF front end 1088 may use one or more switches 1092 to select a transmit or receive path using a specified filter 1096, LNA 1090, and/or PA 1098, based on a configuration as specified by transceiver 1002 and/or processor 1012.

As such, transceiver 1002 may be configured to transmit and receive wireless signals through one or more antennas 1065 via RF front end 1088. In an aspect, transceiver may be tuned to operate at specified frequencies such that UE 110 may communicate with, for example, the BS 105 or one or more cells associated with the BS 105. In an aspect, for example, the modem 140 may configure transceiver 1002 to operate at a specified frequency and power level based on the UE configuration of the UE 110 and the communication protocol used by the modem 140.

In an aspect, the modem 140 may be a multiband-multimode modem, which may process digital data and communicate with transceiver 1002 such that the digital data is sent and received using transceiver 1002. In an aspect, the modem 140 may be multiband and be configured to support multiple frequency bands for a specific communications protocol. In an aspect, the modem 140 may be multimode and be configured to support multiple operating networks and communications protocols. In an aspect, the modem 140 may control one or more components of UE 110 (e.g., RF front end 1088, transceiver 1002) to enable transmission and/or reception of signals from the network based on a specified modem configuration. In an aspect, the modem configuration may be based on the mode of the modem and the frequency band in use. In another aspect, the modem configuration may be based on UE configuration information associated with UE 110 as provided by the network during cell selection and/or cell reselection.

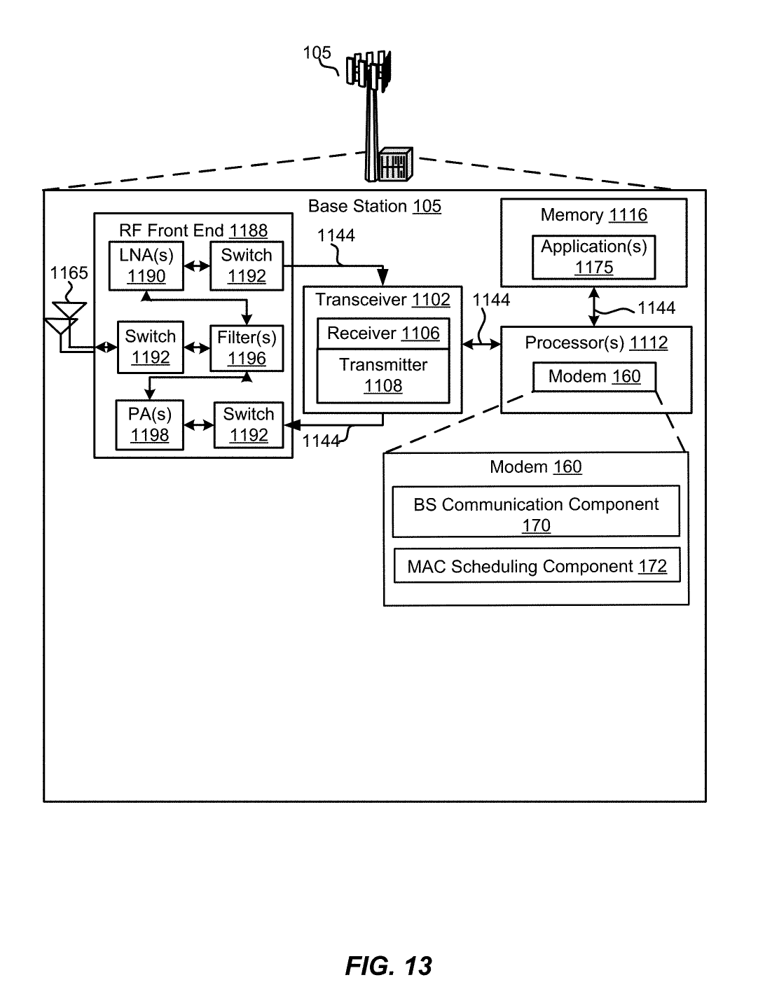

Referring to FIG. 13, one example of an implementation of the BS 105, such as the gNB CU BS 105a, the gNB DU BS 105b, or the relay BSs 105c, may include a variety of components, some of which have already been described above, but including components such as one or more processors 1112 and memory 1116 and transceiver 1102 in communication via one or more buses 1144, which may operate in conjunction with the modem 160 and the BS communication component 170 to enable one or more of the functions described herein related to the synchronization of data receptions at the UEs 110 and at the BS 105. The transceiver 1102, receiver 1106, transmitter 1108, one or more processors 1112, memory 1116, applications 1175, buses 1144, RF front end 1188, LNAs 1190, switches 1192, filters 1196, Pas 1198, and one or more antennas 1165 may be the same as or similar to the corresponding components of the UE 110, as described above, but configured or otherwise programmed for BS operations as opposed to UE operations.

For example, the one or more processors 1112 may include the modem 160 that uses one or more modem processors. The various functions related to the BS communication component 170 and/or the MAC scheduling component 172 may be included in modem 160 and/or processors 1112 and, in an aspect, may be executed by a single processor, while in other aspects, different ones of the functions may be executed by a combination of two or more different processors. For example, in an aspect, the one or more processors 1112 may include any one or any combination of a modem processor, or a baseband processor, or a digital signal processor, or a transmit processor, or a receiver processor, or a transceiver processor associated with transceiver 1102. In certain aspects, various functions relating to the BS communication component 170 the MAC scheduling component 172 may be implemented in hardware, software, or a combination thereof. In other aspects, some of the features of the one or more processors 1112 and/or the modem 160 associated with the BS communication component 170 may be performed by transceiver 1102.

Also, memory 1116 may be configured to store data used herein and/or local versions of applications 1175 or the BS communication component 170 and/or one or more subcomponents of the BS communication component 170 being executed by at least one processor 1112. Memory 1116 may include any type of computer-readable medium usable by a computer or at least one processor 1112, such as random access memory (RAM), read only memory (ROM), tapes, magnetic discs, optical discs, volatile memory, non-volatile memory, and any combination thereof. In an aspect, for example, memory 1116 may be a non-transitory computer-readable storage medium that stores one or more computer-executable codes defining the BS communication component 170 and/or one or more of its subcomponents, and/or data associated therewith, when BS 105 is operating at least one processor 1112 to execute the BS communication component 170 and/or one or more of their subcomponents.

Transceiver 1102 may include at least one receiver 1106 and at least one transmitter 1108. Receiver 1106 may include hardware, firmware, and/or software code executable by a processor for receiving data, the code comprising instructions and being stored in a memory (e.g., computer-readable medium). The receiver 1106 may be, for example, a radio frequency (RF) receiver. In an aspect, the receiver 1106 may receive signals transmitted by the BS 105. Additionally, the receiver 1106, in conjunction with the computation component 150, may process such received signals, and also may obtain measurements of the signals, such as, but not limited to, Ec/Io, SNR, RSRP, RSSI, etc. Transmitter 1108 may include hardware, firmware, and/or software code executable by a processor for transmitting data, the code comprising instructions and being stored in a memory (e.g., computer-readable medium). A suitable example of transmitter 1108 may including, but is not limited to, an RF transmitter.

Moreover, in an aspect, the BS 105 may include RF front end 1188, which may operate in communication with one or more antennas 1165 and transceiver 1102 for receiving and transmitting radio transmissions, for example, wireless communications transmitted by the UE 110/BS 105 or wireless transmissions transmitted by UE 110/BS 105. RF front end 1188 may be coupled with one or more antennas 1165 and may include one or more low-noise amplifiers (LNAs) 1190, one or more switches 1192, one or more power amplifiers (PAs) 1198, and one or more filters 1196 for transmitting and receiving RF signals.

In an aspect, LNA 1190 may amplify a received signal at a desired output level. In an aspect, each LNA 1190 may have a specified minimum and maximum gain values. In an aspect, RF front end 1188 may use one or more switches 1192 to select a particular LNA 1190 and the specified gain value based on a desired gain value for a particular application.

Further, for example, one or more PA(s) 1198 may be used by RF front end 1188 to amplify a signal for an RF output at a desired output power level. In an aspect, each PA 1198 may have specified minimum and maximum gain values. In an aspect, RF front end 1188 may use one or more switches 1192 to select a particular PA 1198 and the specified gain value based on a desired gain value for a particular application.

Also, for example, one or more filters 1196 may be used by RF front end 1188 to filter a received signal to obtain an input RF signal. Similarly, in an aspect, for example, a respective filter 1196 may be used to filter an output from a respective PA 1198 to produce an output signal for transmission. In an aspect, each filter 1196 may be coupled with a specific LNA 1190 and/or PA 1198. In an aspect, RF front end 1188 may use one or more switches 1192 to select a transmit or receive path using a specified filter 1196, LNA 1190, and/or PA 1198, based on a configuration as specified by transceiver 1102 and/or processor 1112.

As such, transceiver 1102 may be configured to transmit and receive wireless signals through one or more antennas 1165 via RF front end 1188. In an aspect, transceiver may be tuned to operate at specified frequencies such that BS 105 may communicate with, for example, the UE110/BS 105 or one or more neighboring cells. In an aspect, for example, the modem 160 may configure transceiver 1102 to operate at a specified frequency and power level based on the BS configuration of the BS 105 and the communication protocol used by the modem 160.

In an aspect, the modem 160 may be a multiband-multimode modem, which may process digital data and communicate with transceiver 1102 such that the digital data is sent and received using transceiver 1102. In an aspect, the modem 160 may be multiband and be configured to support multiple frequency bands for a specific communications protocol. In an aspect, the modem 160 may be multimode and be configured to support multiple operating networks and communications protocols. In an aspect, the modem 160 may control one or more components of BS 105 (e.g., RF front end 1188, transceiver 1102) to enable transmission and/or reception of signals from the network based on a specified modem configuration. In an aspect, the modem configuration may be based on the mode of the modem and the frequency band in use. In another aspect, the modem configuration may be based on BS configuration information associated with BS 105 as provided by the network during cell selection and/or cell reselection.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description herein, however, describes an LTE/LTE-A system or 5G system for purposes of example, and LTE terminology is used in much of the description below, although the techniques may be applicable other next generation communication systems.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of wireless communication, comprising:
appending an extension header to a medium access control (MAC) sub-header, wherein the extension header includes information related to an extension of a logical channel range;
indicating the appending of the extension header by an indicator in the MAC sub-header; and
transmitting the MAC sub-header.

2. The method of claim 1, wherein the indicator comprises at least one of a reserved bit and a dedicated logical channel identifier (LCD) value of an LCID field of the MAC sub-header.

3. The method of claim 2, wherein appending the extension header includes appending a value of an extended logical channel identifier (xLCID) when the indicator comprises the dedicated LCID value.

4. The method of claim 2, wherein appending the extension header includes appending an LCID suffix when the indicator comprises the reserved bit, wherein an LCID value combined with the LCID suffix define an extended logical channel identifier (xLCID).

5. The method of claim 1, wherein appending the extension header further includes a routing ID, an adaptation layer ID, a routing ID, a tunnel ID, or a flow ID.

6. The method of claim 1, wherein the extension header includes a plurality of control bits, a plurality of reserved bits, a length field, a type field, or a value field.

7. The method of claim 1, wherein a first logical channel is configured to transmit a first MAC sub-header having the extension header and a second logical channel is configured to transmit a second MAC sub-header excluding the extension header.

8. The method of claim 1, further comprising:
sending a Layer-3 (L3) capabilities message including an indication for supporting an extended range of the extended logical channel ID.

9. The method of claim 8, wherein the L3 capabilities message is based at least on one of a Radio Resource Control protocol or a F1 Application protocol.

10. The method of claim 1, further comprising:
sending a Layer-3 (L3) configurations message including an indication for supporting an extended range of the extended logical channel ID.

11. The method of claim 10, wherein the L3 configurations message is based at least on one of a Radio Resource Control protocol or a F1 Application protocol.

12. The method of claim 1, further comprising:
scheduling first data for a first logical channel with a first identifier of a first extended range with a first priority;
scheduling second data for a second logical channel with a second identifier of a second extended range with a second priority; and
wherein one of the first identifier of the first extended range or the second identifier of the second extended range corresponds to an extended logical channel ID (xLCID) identified by the extension header.

13. The method of claim 1, further comprising:
receiving data from a first extended logical channel with a first identifier of an extended range with a first priority;
routing the data to a second extended logical channel with a second identifier of the extended range with a second priority based on a mapping between the first identifier and the second identifier.

14. The method of claim 13, further comprising:
sending or receiving a Layer-3 (L3) configurations message including the mapping between the first extended logical channel on a first link and the second extended logical channel on a second link.

15. A base station, comprising:
a memory;
a transceiver; and
one or more processors operatively coupled to the memory and the transceiver and configured to:
append an extension header to a medium access control (MAC) sub-header, wherein the extension header includes information related to an extension of a logical channel range;
indicate the appending of the extension header by an indicator in the MAC sub-header; and
transmit, via the transceiver, the MAC sub-header.

16. The base station of claim 15, wherein the indicator comprises at least one of a reserved bit and a dedicated logical channel identifier (LCD) value of an LCID field of the MAC sub-header.

17. The base station of claim 16, wherein to append the extension header the one or more processors are further configured to append a value of an extended logical channel identifier (xLCID) when the indicator comprises the dedicated LCID value.

18. The base station of claim 16, wherein to append the extension header the one or more processors are further configured to append an LCID suffix when the indicator comprises the reserved bit, wherein an LCID value combined with the LCID suffix define an extended logical channel identifier (xLCID).

19. The base station of claim 15, wherein to append the extension header the one or more processors are further configured to append a routing ID, an adaptation layer ID, a routing ID, a tunnel ID, or a flow ID.

20. The base station of claim 15, wherein the extension header includes a plurality of control bits, a plurality of reserved bits, a length field, a type field, or a value field.

21. The base station of claim 15, wherein a first logical channel is configured to transmit a first MAC sub-header having the extension header and a second logical channel is configured to transmit a second MAC sub-header excluding the extension header.

22. The base station of claim 15, wherein the one or more processors are configured to send a Layer-3 (L3) capabilities message including an indication for supporting an extended range of the extended logical channel ID.

23. The base station of claim 22, wherein the L3 capabilities message is based at least on one of a Radio Resource Control protocol or a F1 Application protocol.

24. The base station of claim 15, wherein the one or more processors are configured to send a Layer-3 (L3) configurations message including an indication for supporting an extended range of the extended logical channel ID.

25. The base station of claim 24, wherein the L3 configurations message is based at least on one of a Radio Resource Control protocol or a F1 Application protocol.

26. The base station of claim 15, wherein the one or more processors are configured to:
schedule first data for a first logical channel with a first identifier of a first extended range with a first priority;
schedule second data for a second logical channel with a second identifier of a second extended range with a second priority; and
wherein one of the first identifier of the first extended range or the second identifier of the second extended range corresponds to an extended logical channel ID (xLCID) identified by the extension header.

27. The base station of claim 15, wherein the one or more processors are configured to:
receive data from a first extended logical channel with a first identifier of an extended range with a first priority; and
route the data to a second extended logical channel with a second identifier of the extended range with a second priority based on a mapping between the first identifier and the second identifier.

28. The base station of claim 27, wherein the one or more processors are configured to send or receive a Layer-3 (L3) configurations message including the mapping between the first extended logical channel on a first link and the second extended logical channel on a second link.

29. A non-transitory computer-readable medium having instructions stored therein that, when executed by one or more processors at a base station, cause the one or more processors to:
append an extension header to a medium access control (MAC) sub-header, wherein the extension header includes information related to an extension of a logical channel range;
indicate the appending of the extension header by an indicator in the MAC sub-header; and
transmit the MAC sub-header.

30. The non-transitory computer-readable medium of claim 29, wherein the indicator comprises at least one of a reserved bit and a dedicated logical channel identifier (LCID) value of an LCID field of the MAC sub-header.

31. The non-transitory computer-readable medium of claim 30, wherein to append the extension header includes to append a value of an extended logical channel identifier (xLCID) when the indicator comprises the dedicated LCID value.

32. The non-transitory computer-readable medium of claim 30, wherein to append the extension header includes to append an LCID suffix when the indicator comprises the reserved bit, wherein an LCID value combined with the LCID suffix define an extended logical channel identifier (xLCID).

33. The non-transitory computer-readable medium of claim 29, wherein to append the extension header further includes to append a routing ID, an adaptation layer ID, a routing ID, a tunnel ID, or a flow ID.

34. The non-transitory computer-readable medium of claim 29, wherein the extension header includes a plurality of control bits, a plurality of reserved bits, a length field, a type field, or a value field.

35. The non-transitory computer-readable medium of claim 29, wherein a first logical channel is configured to transmit a first MAC sub-header having the extension header and a second logical channel is configured to transmit a second MAC sub-header excluding the extension header.

36. The non-transitory computer-readable medium of claim 29, further comprising instructions that, when executed by the one or more processors at the base station, cause the one or more processors to send a Layer-3 (L3) capabilities message including an indication for supporting an extended range of the extended logical channel ID.

37. The non-transitory computer-readable medium of claim 36, wherein the L3 capabilities message is based at least on one of a Radio Resource Control protocol or a F1 Application protocol.

38. The non-transitory computer-readable medium of claim 29, further comprising instructions that, when executed by the one or more processors at the base station, cause the one or more processors to send a Layer-3 (L3) configurations message including an indication for supporting an extended range of the extended logical channel ID.

39. The non-transitory computer-readable medium of claim 38, wherein the L3 configurations message is based at least on one of a Radio Resource Control protocol or a F1 Application protocol.

40. The non-transitory computer-readable medium of claim 29, further comprising instructions that, when executed by the one or more processors at a base station, cause the one or more processors to:
schedule first data for a first logical channel with a first identifier of a first extended range with a first priority;
schedule second data for a second logical channel with a second identifier of a second extended range with a second priority; and
wherein one of the first identifier of the first extended range or the second identifier of the second extended range corresponds to an extended logical channel ID (xLCID) identified by the extension header.

41. The non-transitory computer-readable medium of claim 29, further comprising instructions that, when executed by the one or more processors at a base station, cause the one or more processors to:
receive data from a first extended logical channel with a first identifier of an extended range with a first priority; and
route the data to a second extended logical channel with a second identifier of the extended range with a second priority based on a mapping between the first identifier and the second identifier.

42. The non-transitory computer-readable medium of claim 41, further comprising instructions that, when executed by the one or more processors at a base station, cause the one or more processors to send or receive a Layer-3(L3) configurations message including the mapping between the first extended logical channel on a first link and the second extended logical channel on a second link.

43. A method of wireless communication, comprising:
receiving, at a user equipment, a medium access control (MAC) sub-header;
identifying an indicator in the MAC sub-header that indicates presence of an extension header having information related to an extension of a logical channel range;
reading the extension header to obtain an extended logical channel identifier corresponding to the extension of the logical channel range; and
configuring an extended logical channel based on the extended logical channel identifier.

44. A user equipment, comprising:
a memory;
a transceiver;
one or more processors operatively coupled to the memory and the transceiver and configured to:
receive a medium access control (MAC) sub-header;
identify an indicator in the MAC sub-header that indicates presence of an extension header having information related to an extension of a logical channel range;
read the extension header to obtain an extended logical channel identifier corresponding to the extension of the logical channel range; and
configure an extended logical channel based on the extended logical channel identifier.

45. A computer-readable medium having instructions stored therein that, when executed by one or more processors, cause the one or more processors to:
receive, at a user equipment, a medium access control (MAC) sub-header;
identify an indicator in the MAC sub-header that indicates presence of an extension header having information related to an extension of a logical channel range;
read the extension header to obtain an extended logical channel identifier corresponding to the extension of the logical channel range; and
configure an extended logical channel based on the extended logical channel identifier.

46. A method of wireless communication, comprising:
receiving, at base station, a medium access control (MAC) sub-header;
determining a presence of an extension header based on a value of an indicator in the MAC sub-header;
retrieving an extended logical channel identifier (xLCID) from the extension header;
extracting a MAC service data unit (SDU) from the MAC sub-header; and
forwarding the MAC SDU to a logical channel based on the xLCID.

47. A base station, comprising:
a memory;
a transceiver;
one or more processors operatively coupled to the memory and the transceiver and configured to:
receive, via the transceiver, a medium access control (MAC) sub-header;
determining a presence of an extension header based on a value of an indicator in the MAC sub-header;
retrieving an extended logical channel identifier (xLCID) from the extension header;
extracting a MAC service data unit (SDU) from the MAC sub-header; and
forwarding the MAC SDU to a logical channel based on the xLCID.

48. A computer-readable medium having instructions stored therein that, when executed by one or more processors, cause the one or more processors to:
receive, at base station, a medium access control (MAC) sub-header;
determine a presence of an extension header based on a value of an indicator in the MAC sub-header;
retrieve an extended logical channel identifier (xLCID) from the extension header;
extract a MAC service data unit (SDU) from the MAC sub-header; and
forward the MAC SDU to a logical channel based on the xLCID.
